(19) United States
(12) Patent Application Publication
(10) Pub. No.: US 2025/0039998 A1
(43) Pub. Date: Jan. 30, 2025

(54) INDUCTION COIL UNIT AND METHOD FOR CONTROLLING AN INDUCTIVE HEATING PROCESS FOR AN INDUCTION COIL UNIT

(71) Applicant: Haimer GmbH, Hollenbach-Igenhausen (DE)

(72) Inventor: Antonin Podhrazky, Jemnice (CZ)

(21) Appl. No.: 18/783,738

(22) Filed: Jul. 25, 2024

(30) Foreign Application Priority Data
Jul. 25, 2023 (DE) 10 2023 119 708.8

(51) Int. Cl. H05B 6/06; H05B 6/14

(52) U.S. Cl. CPC H05B 6/06; H05B 6/14

(57) ABSTRACT

An induction coil unit has an induction coil into which a sleeve portion of a tool holder is able to be inserted. The induction coil unit is used in an inductive heating process. To increase the degree of automation and operational safety in the induction coil unit, a temporal profile or a frequency profile of a coil current and/or of a coil voltage and/or of an input current and/or of an input voltage are or is determined for the sleeve portion inserted into the induction coil. The coil current profile and/or the coil voltage profile and/or the input current profile and/or the input voltage profile are or is then analyzed. Based on the analyzed profile or the evaluated profiles, namely based on a profile behavior and/or else a profile change and/or a profile change behavior, a decision is made as to whether the uninterrupted heating process is continued or ended.

### CROSS-REFERENCE TO RELATED APPLICATION

This application claims the priority, under 35 U.S.C. § 119, of German Patent Application DE 10 2023 119 708.8, filed Jul. 25, 2023; the prior application is herewith incorporated by reference in its entirety.

### FIELD AND BACKGROUND OF THE INVENTION

The invention relates to an induction coil unit with an induction coil into which a sleeve portion of a tool holder is able to be inserted, and to a method for controlling an inductive heating process for an induction coil unit with a sleeve portion of a tool holder inserted in an induction coil of the induction coil unit.

Such generic induction coil units are known from the prior art, for example from European patent application EP 1 867 211 A1, corresponding to U.S. Pat. No. 9,278,414.

These known induction coil units are used to thermally expand tool holders by way of alternating magnetic fields able to be generated by induction coils and the eddy currents thereby induced in the tool holders inserted in the induction coils of the induction coil units, in order to be able to insert a tool into the tool holder in this expanded state thereof, the tool then being held firmly and symmetrically by the tool holder after a cooling process of the tool holder. This process is also referred to—for short—as induction shrink-fitting of tools in tool holders, and is known as such.

For a more detailed description of the technical and operational background, reference should therefore be made to the abovementioned patent application.

In such a known induction coil unit, however, the problem arises that, for efficient operation thereof, that is to say the induction shrink-fitting of tools into tool holders, in particular during heating of the tool holders, the induction coil unit needs to be adjusted with regard to various operating parameters, such as in particular, inter alia, a heating time, in each case individually to the tool holder currently held therein, which requires a high degree of manual intervention and thus in some cases significantly extends the cycle times for changing a tool in different types of tool holders. Beyond this, manual interventions are also always potential sources of errors.

On the other hand, if such an adjustment is not carried out, or is carried out incorrectly, on the tool holder currently being held, the operation of the induction coil unit may be inefficient in some cases, since the intended eddy currents are not induced appropriately in the tool holder. In particularly unfavorable cases, such as for example in the event of excessively long heating times, the tool holder may even overheat and thus be destroyed.

### SUMMARY OF THE INVENTION

The object of the present invention is therefore to provide an induction coil unit and a method for controlling an inductive heating process for an induction coil unit that is able to overcome the abovementioned disadvantages of such induction coil units known from the prior art, wherein the induction coil unit may in particular have an increased degree of automation and is therefore able to be operated with shorter cycle times while maintaining a high degree of operational safety.

This object is achieved by an induction coil unit and a method for controlling an inductive heating process for an induction coil unit having the features of the respective independent claim. Advantageous developments of the invention are the subject of dependent claims and of the following description and relate both to the induction coil unit and to the method for controlling an inductive heating process for an induction coil unit.

Any terms that are used, such as above, below, front, rear, left or right—unless explicitly defined otherwise—should be understood in the usual way—including with regard to the present figures. Terms such as radial and axial, where used and not explicitly defined otherwise, should be understood in relation to center axes, or axes of symmetry, of component parts/components described here-including with regard to the present figures.

The expression “substantially”—where used—may (in accordance with the understanding of the Supreme Court) be understood to mean “to a practically still significant degree”. Possible deviations from exactness that are thus implied by this concept may arise unintentionally (that is to say without any functional basis) owing to manufacturing or assembly tolerances or the like.

The induction coil unit along with the method for controlling an inductive heating process for an induction coil unit provide an induction coil in the induction coil unit into which a sleeve portion of a tool holder is able to be inserted (as far as the arrangement is concerned) or is inserted (as far as the method is concerned).

### Method

In the method for controlling an inductive heating process for an induction coil unit, for example a shrinking device, with a sleeve portion of a tool holder inserted into an induction coil of the induction coil unit, provision is made that during the, in particular uninterrupted, inductive heating process in the sleeve portion inserted into the induction coil, a temporal profile or a frequency profile:
of a coil current, in short and simple terms, the amperage of the coil current produced in the coil or in a coil circuit over time or over frequency, and/or
of a coil voltage, in short and other terms, the voltage of the coil current present at the coil or able to be tapped off in the coil circuit over time or over frequency, and/or
of an input current and/or of an input voltage, in short and simple terms, the amperage and/or the voltage of a current produced upstream of the coil or upstream of the coil circuit, for example of the current produced in an input circuit or an intermediate circuit, over time or over frequency, and
are or is determined for the sleeve portion inserted into the induction coil.

A temporal profile or a frequency profile (sometimes also referred to as frequency characteristic) may be understood here, illustratively and in simple terms, to mean in particular a mapping or relationship in which a mapping variable of a mapping rule, which mapping rule maps a mapping variable to a second mapped variable, is a time or a frequency. The mapped second variable may then thus in this case be the abovementioned coil current and/or coil voltage and/or input current and/or input voltage—or else a variable able to be derived or obtained/calculated therefrom, such as phase position or phase shift.

Mathematically, this may be able to be expressed in simplified form by:

(coil current/coil voltage/input current/input voltage(or derived variable))=f(time or frequency)
with: f=mapping rule/relationship.

Furthermore, the (coil current) profile and/or the (coil voltage) profile and/or the (input current) profile and/or the (input voltage) profile—or the derived variable—are or is then analyzed.

Based on the analyzed profile or the evaluated profiles, in particular based on a profile behavior and/or else a profile change and/or a profile change behavior, a decision is made as to whether the, in particular uninterrupted, heating process is continued or ended.

Analyzed may then thus mean here that the profile behavior and/or the profile change and/or the profile change behavior of the temporal or frequency profile is determined or investigated, in particular based on determinable parameters.

Here, the profile behavior may be understood to mean in particular changes in the profile, for example rising, falling and/or unchanged profiles, and also a curvature behavior of the profile, whereas profile change/behavior is understood to mean changes in the profile itself or as a whole; for example, there is a change in the profile over time and/or the heating temperature of the sleeve portion inserted into the induction coil, that is to say generally a third dimension.

The invention is based on the finding that there is a change in the magnetic property, such as a magnetic permeability, of the sleeve portion inserted into the induction coil, and thus the inductance of the overall system—also containing the induction coil and the sleeve portion inserted therein—and/or an electrical property, such as an electrical resistance of the overall system, on the basis of the heating or the heating temperature of the sleeve portion inserted into the induction coil.

The change in permeability or inductance is in this case, as has been identified, more pronounced the closer the heating temperature of the sleeve portion inserted into the induction coil gets to its Curie temperature Tc. On the other hand, the change in the electrical property, such as resistance, is dominant in the case of a greater distance from the Curie temperature Tc, such as for example at the start of heating, below the Curie temperature Tc.

This in turn means that it is possible to recognize the temperature-dependent change in permeability, inductance and/or electrical property or the electrical resistance by way of “dynamics” in the profile or else the profile change/profile change behavior, or the change is reflected there—in particular with a different influence or dominance in different temperature ranges.

It has also been identified here that this is reflected in particular in the coil current, the coil voltage and in the input current and the input voltage—and thus also in the variables able to be derived or obtained/calculated therefrom, such as phase position or phase shift.

Expressed in simplified and briefly descriptive terms, in the lower temperature range, in particular the change in resistance will be reflected in the coil current, the coil voltage and in the input current and the input voltage or in the variables able to be derived or obtained/calculated therefrom, such as phase position or phase shift, and, when approaching or close to the Curie temperature Tc, the change in permeability/inductance will be reflected therein.

In other words, the profile most reliably describing/mapping/tracking a (heating) state of the inserted sleeve portion or most reliably describing/mapping the recognized temperature-dependent effect is that of the coil current, the coil voltage and the input current and the input voltage or variables derived therefrom.

A parameter (or multiple parameters) that recognizes/maps these dynamics or this change makes it possible to take this change into account/to make it comprehensible (in analytical terms)—and thus allows it to be used to define a decision criterion with regard to heating of the inserted sleeve portion.

Such a parameter-describing the profile dynamics or the profile behavior or the profile change/the profile change behavior—may for example—in particular in the case of temporal profiles-map or represent a change of amplitude (values), in particular of amplitude extrema, in particular of amplitude maxima, such as for example the fact that amperages or voltages drop/decrease or remain constant or increase/rise.

Such a parameter—describing the profile dynamics or the profile behavior or the profile change/the profile change behavior—may for example—in particular in the case of frequency profiles—also be an amplitude extremum, in particular a resonant frequency, an amplitude extremum change, a variance or curve width/bandwidth or a variance/curve width/bandwidth change and/or a resonant frequency change.

In other words, in simple and illustrative terms, such a parameter-describing the profile dynamics or the profile behavior or the profile change/the profile change behavior—is not simply a simple characteristic variable that statically describes a certain state during power transmission or power consumption (such as for example a certain amperage/voltage value at a certain time or in the temporal profile), but rather a more extensive characteristic variable that goes beyond this and that maps “dynamics” in the temporal or frequency profile/in the frequency profile change.

Simply put—mathematically speaking—a (mathematical) characteristic variable or a higher-order derivative in the temporal profile or frequency profile/frequency profile change.

It is thus particularly expedient when—for example—the profile dynamics are described using a derivative or tangent to the profile or profile change—and/or to a connecting curve that connects amplitude values, in particular the amplitude maxima, of the profile, in particular of the temporal profile. In short, in this case, the parameter would be a tangent.

In other words, the parameter may—expediently mathematically speaking—be a derivative of or a tangent to the profile, in particular temporal profile—and thus maps the, in particular temporal, change in the coil current or the coil voltage or the input current or the input voltage.

The decision as to whether the heating process is continued or ended may then be made in particular using such a derivative or one or more tangents, in particular using the change in one or more slopes of the one or more tangents.

In particular, transitions in the slope of the tangent may be of significant importance/decision—making significance here, such as for example the transition from a falling tangent to a horizontal tangent or vice versa or a horizontal tangent to a rising tangent or vice versa.

By way of example, if the parameters of the temporal profile of the coil current, of the coil voltage and/or of the input current and/or of the input voltage thus exhibit a horizontal profile or a rising profile or the transition from a falling tangent to a horizontal tangent or the transition from a horizontal tangent to a rising tangent, then the heating process may be aborted in the event of such behavior (“abort behavior”).

The same applies in the same way to the curvature and/or curvature behavior of the profile.

In particular, the abort may be performed for example as soon as—only one of, or the first one (in time)—the (profile) parameter exhibits the defined, described abort behavior—or—alternatively—only when multiple or all (profile) parameters (here of coil current, coil voltage, input current and input voltage) exhibit the predeterminable abort behavior ((predefinable) “abort criterion”).

Separate abort criteria may in this case also be defined-on a sleeve portion-specific basis—in each case separately for a specific sleeve portion or for specific sleeve portions, for example such that several or all parameters have to exhibit the abort behavior for diameters of larger sleeve portions, whereas only one parameter has to exhibit the abort behavior for diameters of smaller sleeve portions.

It may be particularly expedient here to determine an effective current or voltage profile of the determined time/frequency profiles—and if this is taken as a further basis for the parameter determination, the effective profiles reproduce the actual current or voltage profile more realistically.

The same applies when the determined time/frequency profile is measured, smoothed, averaged, filtered and/or normalized.

In particular, it may also be expedient to normalize the profiles to a reference voltage, for example to a German reference mains voltage. Such normalization allows the method to be independent of any particular country with the respective mains voltage there.

In addition, it may also be expedient if the decision is also made on the basis of a geometry or other physical property, such as for example a material or a mass, of the sleeve portion inserted into the induction coil of the induction coil unit. Such a geometry may be for example an outside diameter of the inserted sleeve portion.

This is based on the fact that variables to be measured (in addition to temperature as well) depend decisively on the extent to which the sleeve portion fills the center or the so-called core of the induction coil, that is to say whether the sleeve portion in question has a smaller or larger (outside) diameter or more or less mass.

Specifically, in the case of induction shrink-fitting devices or shrinking devices, the sleeve portion of the tool holder inserted into the space circumferentially enclosed by the induction coil forms an essential component part of the magnetic circuit. Specifically, the sleeve portion forms the metal core of the induction coil. The extent of the inductance to be measured therefore depends decisively on the extent to which the sleeve portion fills the center or the so-called core of the induction coil, that is to say whether the sleeve portion in question has a smaller or larger (outside) diameter or more or less mass.

In this respect, it is then expedient here if the geometry or the outside diameter of the sleeve portion inserted into the induction coil is determined before the start—in particular in automated fashion—and the inserted sleeve portion is thus “recognized”. This is described for example in German patent application Nos. 10 2015 016 831.2 and 10 2019 112 521.9, and in European patent application No. 19 17 6562.7. The content thereof is hereby incorporated into the subject matter of this application.

If the inserted sleeve portion is then recognized, then it is possible to determine or define heating parameters for the inserted sleeve portion or its heating process.

Such heating parameters may in particular be a shrinkage/heating frequency and/or a shrinkage/heating temperature and/or a time for the heating process and/or a maximum time for the heating process and/or an energy (current integral).

It is thus also particularly expedient to define the frequency for the (heating) current (that is to say the shrinkage/heating frequency) close to the resonant frequency, for example “just” below or above it, in particular “just” above it; as the shrinkage/heating frequency approaches the resonant frequency, the efficiency/effectiveness of the heating increases. Defining the shrinkage/heating frequency to be equal to the resonant frequency should be avoided, otherwise resonance effects may lead to overloading of component parts in the induction coil unit.

Furthermore, it may also be expedient to determine the profiles or the temporal profile and/or the frequency profile through measurement. An appropriate measuring implement (or a functionally equivalent circuit) or appropriate measuring implements (or circuits) may be provided in the induction coil unit.

If the amperages are to be measured in this way, it is expedient to use series-connected current (amperage) measuring implements, such as ammeters or multimeters, or even a measuring coil; if the voltage is to be measured, it is expedient to use a parallel-connected voltmeter.

Such measurement of the profiles may in this case be carried out in an input circuit of a circuit of the induction coil unit and/or an intermediate circuit of the induction coil unit and/or output circuit or on the induction coil.

The measurements may also be carried out in parallel (in time) at several of the abovementioned points of the circuit.

### Unit

In the induction coil unit—for performing the method-provision is furthermore also made for a circuit by way of which the induction coil is able to be supplied with power.

It may be expedient for the circuit to have at least one power semiconductor component, in particular at least one insulated-gate bipolar transistor (IGBT) and/or a metal-oxide-semiconductor field-effect transistor (MOSFET)—these have good forward behavior, high reverse voltages and robustness—and are also able to be driven with almost no power.

Furthermore, in the induction coil unit, provision is also made for a control unit by way of which the induction coil and the circuit are able to be controlled. The control unit is furthermore configured such that—in short—the method (in terms of its basic features, as in particular also with all the embodiments and developments described above) is able to be performed.

This also means in particular that the control unit-controlling the induction coil and the circuit—is configured such that during the, in particular uninterrupted, inductive heating process in the sleeve portion inserted into the induction coil, the temporal profile or the frequency profile of the coil current and/or of the coil voltage and/or of the input current and/or of the input voltage are or is able to be determined for the sleeve portion inserted into the induction coil, and also the (coil current) profile and/or the (coil voltage) profile and/or the (input current) profile and/or the (input voltage) profile, possibly including their derived variables, are or is able to be analyzed, and a decision is able to be made, based on the analyzed profile or the evaluated profiles, in particular based on a profile behavior and/or a profile change and/or a profile change behavior, as to whether the, in particular uninterrupted, heating process is continued or ended.

It is also expedient if provision is made for one or more measuring apparatuses by way of which the one or more temporal profiles or the one or more frequency profiles are or is able to be measured.

Preferably, the measuring apparatus is in this case a current measuring apparatus or a voltage measuring apparatus.

Also preferably, the measuring apparatus may be installed in an input circuit and/or in an intermediate circuit and/or in an output circuit of the circuit.

Preferably, the method (along with the induction coil unit) may also be used to recognize an already warm sleeve portion of a tool holder inserted into the induction coil of the induction coil unit. The preheating state of the sleeve portion is identified here using the determined parameters.

If for example the parameters of the temporal profiles already exhibit a horizontal profile or a rising profile at the beginning of the heating process for an inserted sleeve portion, then this indicates a sleeve portion that has already been preheated.

Since, by virtue of the method, and in the case of the induction coil unit as well, it is possible to carry out largely automatic or automated operation, that is to say the induction shrink-fitting of tools into tool holders, in particular the heating of the tool holders, for a respective tool holder just inserted in the induction coil unit, manual interventions for the purpose of setting operating parameters become superfluous in this case, meaning that, on the one hand, the time previously required for this is saved and, on the other hand, the automatic/automated operation also makes it possible to comply with high standards with regard to operational safety and tolerances in order to be able to ensure that the unit is operated in accordance with regulations. Efficient protection against overheating of a tool holder to be heated/expanded may also be achieved by virtue of the method and in the case of the induction coil unit.

The description given so far of advantageous configurations of the invention includes numerous features that are reproduced in the individual dependent claims, in some cases together. However, these features may expediently also be considered individually and combined into appropriate further combinations.

In particular, these features may each be combined individually and in any suitable combination with the method according to the invention.

Even though some terms are used in each case in the singular or in combination with a numeral in the description and/or in the patent claims, the scope of the invention is not intended to be limited to the singular or the respective numeral for these terms. Furthermore, the words “a” or “an” should not be understood as numerals, but as indefinite articles.

The properties, features and advantages of the invention that are described above and the manner in which they are achieved will become clearer and more clearly understandable in conjunction with the following description of the exemplary embodiments of the invention, which are explained in greater detail in conjunction with the drawing(s)/figure(s) (identical component parts/components and functions have the same reference signs in the drawings/figures).

The exemplary embodiments are used to explain the invention and do not restrict the invention to the combinations of features, including with respect to functional features, that are specified therein. For this purpose, it is moreover also possible for suitable features of each exemplary embodiment to be considered explicitly in isolation, removed from one exemplary embodiment, introduced into another exemplary embodiment in order to supplement the latter and combined with any one of the claims.

Other features which are considered as characteristic for the invention are set forth in the appended claims.

Although the invention is illustrated and described herein as embodied in an induction coil unit and a method for controlling an inductive heating process for an induction coil unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a mid-longitudinal sectional view of an induction coil unit according to one embodiment of the invention;

FIG. 2 is a circuit diagram of a circuit for feeding an induction coil able to be used for the induction coil unit;

FIG. 3 is a graph showing a temporal profile of a coil current in a case of a sleeve portion inserted into the induction coil of an induction coil unit during shrinking; and

FIG. 4 is an idealized temporal profile of an RMS coil current according to FIG. 3.

### DETAILED DESCRIPTION OF THE INVENTION

The invention relates to automated heating control of a shrinking process using a shrinking device.

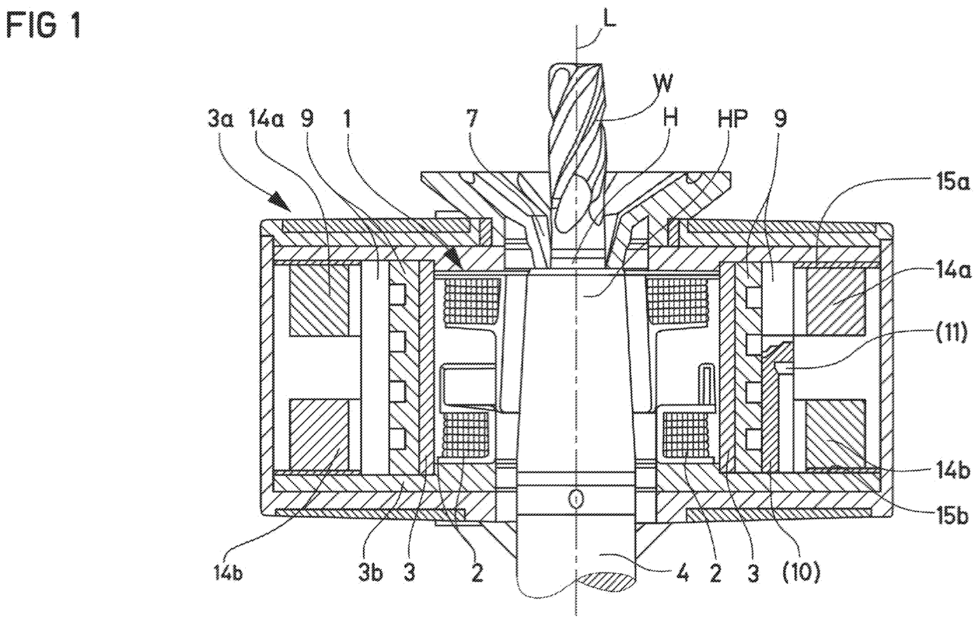

Referring now to the figures of the drawings in detail and first, particularly to FIG. 1 thereof, there is shown a basic structure of an induction coil unit, which will also be referred to (hereinafter) as a shrinking device due to its intended function here.

As FIG. 1 illustrates, the shrinking device provides an induction coil 1 with individual turns 2, in the center of which a tool holder 4 is inserted in order to shrink or release the holding shaft H of a tool W, such as here for example a milling cutter, into or from the sleeve portion HP.

The operating principle on which the shrinking and releasing is based is described in more detail in German patent application DE 199 15 412 A1, corresponding to U.S. Pat. No. 6,991,411. The content thereof is hereby incorporated into the subject matter of this application.

On its outside circumference, the induction coil 1 is provided with a first sheath 3 made of electrically non-conductive and magnetically conductive material.

Typically, the first sheath 3 consists of either a ferrite or a metal powder or metal sintered material the individual particles of which are isolated from one another in electrically insulated fashion and which are thereby, on the whole, substantially magnetically conductive and electrically non-conductive.

The first sheath 3 is also configured such that it is completely self-enclosed in the circumferential direction, that is to say completely covers the peripheral surface of the induction coil 1, such that, in theory, there are also no remaining “magnetic gaps” whatsoever, aside from irrelevant local penetrations, such as individual and/or small local bores or the like.

As FIG. 1 also furthermore shows, in the shrinking device, the shielding made of magnetically conductive and electrically non-conductive material does not end with the first sheath 3.

Instead, a magnetic cover 3a, 3b made of the material adjoins at least one, better still both end faces of the first sheath 3, and is generally in contact with the first sheath 3.

On the end face of the induction coil 1 remote from the tool holder 4, the magnetic cover 3a is preferably configured as a completely or preferably partially replaceable pole shoe, that is to say as a ring-shaped structure having a central opening, which forms a passage 7 for the tool W to be clamped in or released.

On the end face of the induction coil 1 facing the tool holder 4, the magnetic cover 3b is preferably configured as an inherently planar annular disk, which ideally fully engages with the windings of the induction coil 1 and has a central passage for the sleeve portion HP.

In order to even further improve the shielding, as FIG. 1 also shows, the induction coil 1 and its first sheath 3, on the outer circumference thereof, are surrounded by a second sheath 9—specifically such that the first sheath 3 and the second sheath 9 touch one another, ideally over the majority of or the entirety of their mutually facing peripheral surfaces.

This second sheath 9 is made of magnetically non-conductive and electrically conductive material, for example aluminum.

“Electrically conductive” is understood here to mean a material that is electrically conductive not just locally, “grain-by-grain” so to speak, but rather a material that permits the formation of eddy currents to a relevant extent.

The special feature of the second sheath 9 is that it is preferably designed, and preferably designed to be thick enough in the radial direction, that eddy currents are produced therein under the influence of the stray field of the induction coil 1 penetrating it, these eddy currents causing a weakening of the undesired stray field.

The second sheath 9 is also surrounded, on its circumference, by the power semiconductor components 10, which will be explained in more detail below, which are arranged directly on the outer circumference of the second sheath 9 in recesses 11 there (only indicated).

These power semiconductor components 10 have two large main surfaces and four small side surfaces. The large main surfaces are preferably more than four times larger than each of the individual side surfaces.

The power semiconductor components 10 are arranged such that one of their large main surfaces is in thermally conductive contact with the second sheath 9, generally on the outer circumference thereof, wherein the relevant large main surface of the power semiconductor component 10 is adhesively bonded to the peripheral surface of the second sheath 9 by way of a thermally conductive adhesive.

Each of the power semiconductor components 10 has different power supply terminals.

Furthermore, as FIG. 1 also shows, capacitors 14a, 14b are grouped together around the induction coil 1 on the outer circumference thereof.

The capacitors 14a are preferably smoothing capacitors that are directly part of a power circuit; the capacitors 14b are preferably resonant circuit capacitors that are likewise directly part of the power circuit.

In order to electrically connect the capacitors 14a, 14b, provision is made here for multiple circuit boards 15a, 15b, each engaging around the outer circumference of the induction coil 1.

Each of these circuit boards 15a, 15b preferably forms an annular disk. Each of the circuit boards 15a, 15b preferably consists of FR4 or similar materials commonly used for circuit boards.

As may also be seen in FIG. 1, the axis of rotational symmetry of each of the two circuit boards 15a, 15b, designed here as circuit board annular disks, is coaxial here to the longitudinal axis L of the induction coil (also of the tool holder 4/tool W).

The upper one of the two circuit boards 15a carries the smoothing capacitors 14a, the connection tabs of which penetrate the upper circuit board 15a or are connected to the upper circuit board 15a using SMD technology, such that the smoothing capacitors 14a hang down from the upper circuit board 15a.

The lower one of the two circuit boards 15b is designed accordingly, and the resonant circuit capacitors 14b protrude upward therefrom.

In summary, the power semiconductors 10 form a first imaginary cylinder that surrounds the induction coil 1; the capacitors 14a, 14b form a second imaginary cylinder that surrounds the first imaginary cylinder; the capacitors 14a, 14b, which are only less sensitive to the stray field, form the imaginary, outer cylinder, while the power semiconductor components 10, which rely on an installation space with as few stray fields as possible, form the imaginary, inner cylinder.

As FIG. 1 also shows, the induction coil 1 is not “fully wound” over its entire length in the direction of its longitudinal axis L. Instead, it consists-here—of two winding packages, which are generally cylindrical. These each form an end face of the induction coil 1. They keep a distance from one another that—by way of example here—is greater by approximately at least a factor of 1.5 than the extent of each of the winding packages in the direction of the longitudinal axis L of the induction coil 1.

Such an induction coil 1 contributes to reducing reactive power, since it does not have the windings in the “central area”, which are not necessarily required from the point of view of achieving the most effective possible heating of the sleeve portion HP of the tool holder, but which-if present—have the tendency to produce additional reactive power, without making a really important contribution to heating.

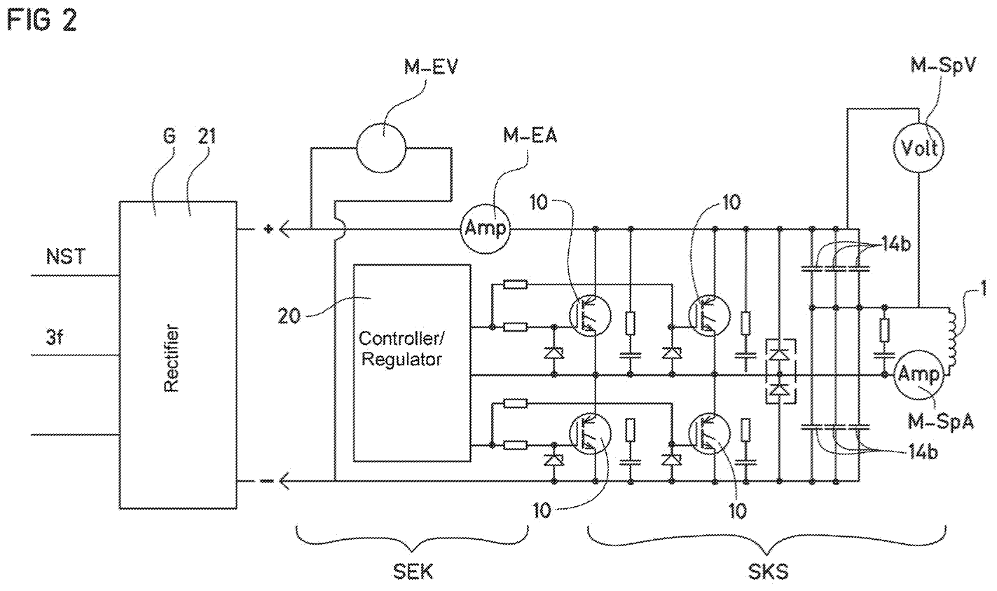

In order to supply the induction coil 1 with power with as few losses as possible, provision is made for a circuit-shown in more detail in FIG. 2.

As FIG. 2 shows, to this end, this circuit has a resonant circuit SKS (cf. FIG. 2).

In the resonant circuit SKS, the majority of the required energy oscillates periodically back and forth (at high frequency) between the induction coil 1 and a capacitor unit 14a, 14b. This means that, in each period or periodically, only the energy extracted from the resonant circuit SKS through its heating power and its other power losses needs to be fed back. The previous very high losses are thus no longer incurred.

The power electronics supplying power to the induction coil 1, as FIG. 2 shows, are supplied on the input side with the generally available mains current NST, which, in Europe (three-phase current, 3f), is 400 V/50 Hz (corresponding values in other countries).

The current taken from the grid, as illustrated in FIG. 2, is converted, by a rectifier G 21, into direct current, which in turn is smoothed by the one or more smoothing capacitors 14a (not shown).

As FIG. 2 furthermore also illustrates, this direct current is supplied to the actual resonant circuit SKS.

The backbone of the resonant circuit SKS is formed by the power semiconductor components 10, the resonant circuit capacitors 14b and the induction coil 1, which serves for shrinking and releasing.

The resonant circuit SKS is controlled or regulated by control electronics SEK, which are supplied with direct current from the rectifier G.

The power semiconductor components 10 are preferably implemented by insulated-gate bipolar transistors, IGBT for short.

The control electronics SEK switch the power semiconductor components 10/IGBT at a frequency that specifies the operating frequency that sets in at the resonant circuit SKS.

It is important that the resonant circuit SKS never operates exactly in resonance.

This would result here in the rapid destruction of the power semiconductor components 10 as a result of the voltage peaks. Instead, the control electronics SEK are designed such that they operate the power electronics or their resonant circuit SKS in a predefinable working range, which is only close to the resonance or natural frequency of the system.

Preferably, the resonant circuit is controlled or regulated (by way of the controller 20) such that 0.9≤cos φ≤0.99. Values in the range 0.95≤cos φ≤0.98 are particularly expedient. This again leads to voltage peaks being avoided, and therefore provides further support for miniaturization.

In order to operate the shrinking device 1 with a certain degree of operational safety—in a manner as automated as possible—the shrinking device is equipped with an automatic heating controller/regulator that enables automated shrinking operation.

This heating controller/regulator is implemented by a corresponding controller or regulator 20 in the shrinking device, which is based-basically-on an analysis of—measured-coil current M-SpA, coil voltage M-SpV and/or input current M-EA and/or input voltage M-EV or their temporal profiles.

In order to measure coil current (M-SpA), coil voltage (M-SpV) and input current (M-EA) and input voltage (M-EV), the circuit, as FIG. 2 also shows, accordingly makes provision for current/voltage measuring implements M-SpA (coil current), M-SpV (coil voltage) or M-EA (input current) or M-EV (input voltage), which are installed accordingly in the circuit at correspondingly shown positions.

If in this case the measured variables or their profile, in the case of an induction coil used for shrinking, also depend on the temperature of the inserted sleeve portion of the tool holder, then this may advantageously be used for-automated-heating control, in order thus—while avoiding “manual” sources of errors because it is automated—to improve safety in a shrinking device.

(Automatic) Recognition of the Tool Holder/Sleeve Portion Currently Inserted into the Shrinking Device or its Induction Coil

Before the start of heating of the sleeve portion (HP, cf. FIG. 1) inserted into the induction coil (1, cf. FIGS. 1 and 2), the geometry or the outside diameter of the sleeve portion inserted into the induction coil is first of all determined—in automated fashion—and the inserted sleeve portion is thus “recognized”.

This is described for example in German patent application Nos. 10 2015 016 831.2 (corresponding to U.S. Pat. No. 11,166,345) and 10 2019 112 521.9 (corresponding to U.S. patent publication No. 2020/0367324), and in European patent application 19 17 6562.7. The content thereof is hereby incorporated into the subject matter of this application.

If the inserted sleeve portion is then recognized, then (previously) defined heating parameters may be defined for the inserted sleeve portion or its heating process, such as, inter alia, in particular the (individual) shrinkage/heating frequency.

The heating process of the inserted sleeve portion is then started at its individual shrinkage/heating frequency, wherein, at the same time as power starts being supplied to the induction coil, the measurement of the coil current, of the coil voltage, of the input current and of the input voltage also begins (cf. circuit according to FIG. 2 in this regard).

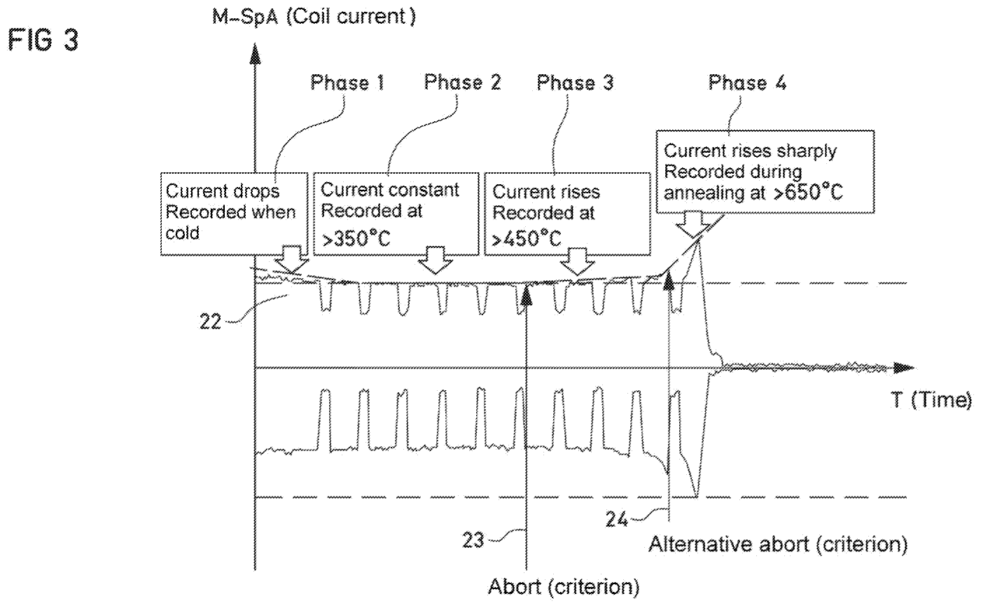

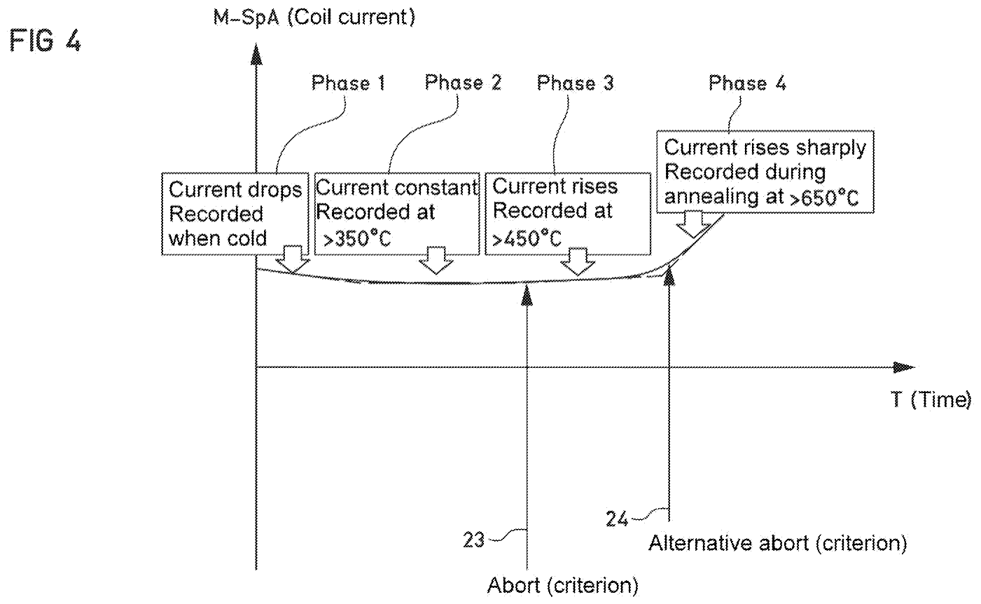

### Automated/Automatically Controlled Shrinking Process (FIGS. 3 and 4)

FIG. 3 (and—in idealized form—FIG. 4) illustrates how the heating process of the inserted sleeve portion is able to be controlled (20) based on the temporal profile 22 of the coil current M-SpA. FIG. 4 corresponds to FIG. 3 with an idealized illustration of the coil current M-SpA (RMS amperage, filtered and smoothed).

The control (20) presented here, based on the coil current profile 22, is also able to be carried out accordingly with the coil voltage M-SpV and/or the input current M-EA and/or the input voltage M-EV or variables derived therefrom, such as phase position and phase shift (since their profiles correspond—in qualitative terms—to that of the coil current).

As FIG. 3 and FIG. 4 illustrate, the coil current M-SpA is measured continuously during the heating process using the mentioned current measuring implement M-SpA (coil current) in the temporal profile (T (time)).

FIGS. 3 and 4 each show a typical (curve) profile 22 of a (measured) coil current M-SpA during the heating of the inserted sleeve portion (starting from the cold sleeve portion until it is annealed, phases 1 to 4).

If relevant for the control, the following may be derived from the coil current profile 22.

As FIGS. 3 and 4 show, the coil current M-SpA first decreases at the outset (and in this case a cold sleeve portion) and then as time goes on and during initial heating of the sleeve portion (phase 1). In other words, the slope of the coil current profile is negative or tangents applied to the coil current profile have a falling profile.

After the initial decrease, the coil current M-SpA then remains approximately constant in the further time/heating profile (that is to say the slope of the coil current profile is zero or tangents applied to the coil current profile have a horizontal profile) (phase 2), wherein the coil current M-SpA then—in the further temporal profile and during further heating (phase 3) (until the sleeve portion is annealed, phase 4)—increases or rises again (that is to say the slope of the coil current profile is positive or tangents applied to the coil current profile have a rising profile). This rise occurs here with an increasing slope/gradient (phases 3 and 4).

The curvature behavior of the coil current profile 22 is also obtained in accordance with the slopes or the falling, rising and horizontal profiles of the tangents.

The coil controller 20 makes use of this-expected-coil current profile 22 by configuring its control based thereon.

In this case-if the measured coil currents M-SpA are transmitted continuously to the controller 20—the controller 20 continuously determines the slope of the coil current profile 22 or the tangents to the coil current profile 22, along with its curvature behavior as well.

If the coil current profile M-SpA then transitions from its horizontal, constant phase to the rising profile (phase 2 to phase 3), that is to say the tangents start to rise again (from the horizontal) or the slope (and curvature) of the coil current profile 22 becomes positive (“abort criterion” 23), the controller 20 shuts down the heating process (automatically); the heating state of the inserted sleeve portion has reached a critical phase/temperature here.

If, as an alternative, higher heating temperatures were desired to be permitted, a slope limit value could also be predefined as an “abort criterion” (slope/tangent in phase 4) (alternative abort/alternative abort criterion 24). If the coil current profile then reaches this predefined limit slope, then the controller 20 would (automatically) shut down the heating process.

The controller thus enables largely automatic or automated shrinking. Manual interventions for the purpose of setting operating parameters are superfluous in this case, meaning that, on the one hand, the time previously required for this is saved and, on the other hand, the automatic/automated operation also makes it possible to comply with high standards with regard to operational safety and tolerances in order to be able to ensure that the unit is operated in accordance with regulations. Efficient protection against overheating of the sleeve portion is also achieved.

Although the invention has been illustrated and described in more detail by the preferred exemplary embodiments, the invention is not restricted by the examples disclosed and other variations can be derived therefrom, without departing from the scope of protection of the invention.

1. A method for controlling an inductive heating process for an induction coil unit with a sleeve portion of a tool holder inserted in an induction coil of the induction coil unit, which comprises the steps of:
during the inductive heating process in the sleeve portion inserted into the induction coil, determining at least one temporal profile or a frequency profile of a coil current and/or of a coil voltage and/or of an input current and/or of an input voltage for the sleeve portion inserted into the induction coil; and
analyzing a coil current profile and/or a coil voltage profile and/or an input current profile and/or an input voltage profile, or variables derived therefrom, and a decision is made, based on an analyzed profile or evaluated profiles, as to whether the inductive heating process is continued or ended.

2. The method for controlling the inductive heating process according to claim 1, which further comprises determining temporal profiles of the coil current, of the coil voltage, of the input current and of the input voltage, profiles of all of the temporal profiles are analyzed, and the decision is made, based on all of the analyzed profiles, as to whether the inductive heating process is continued or ended, and/or wherein a derived variable is a phase position or a phase shift.

3. The method for controlling the inductive heating process according to claim 1, which further comprises mapping the at least one temporal profile or the frequency profile using root mean square current or voltage values.

4. The method for controlling the inductive heating process according to claim 1, wherein in an analysis of the at least one temporal profile, at least one of a profile behavior, a profile change or a profile change behavior is determined, and/or wherein, in an analysis of the frequency profile, at least one of an extremum is determined.

5. The method for controlling the inductive heating process according to claim 1, wherein in an analysis of the at least one temporal profile, current or voltage values at different times of the inductive heating process are analyzed, and/or wherein, in an analysis of the frequency profile, the frequency profile to be analyzed is compared with a reference profile.

6. The method for controlling the inductive heating process according to claim 1, wherein in an analysis of the at least one temporal profile, a plurality of tangents are applied to the at least one temporal profile and a decision is made taking into account a change in slopes of the tangents.

7. The method for controlling the inductive heating process according to claim 1, which further comprises taking into account a geometry and/or other physical property of the sleeve portion inserted into the induction coil of the induction coil unit when making the decision.

8. The method for controlling the inductive heating process according to claim 1, wherein the at least one temporal profile or the frequency profile to be analyzed is smoothed, averaged, filtered and/or normalized to a reference mains voltage before an analysis and/or during the analysis.

9. The method for controlling the inductive heating process according to claim 1, which further comprises determining the at least one temporal profile or the frequency profile using a measurement of a current or a voltage.

10. The method for controlling the inductive heating process according to claim 1, wherein the input current and/or the input voltage is measured in an intermediate circuit, or in an input circuit and/or at a connecting part.

11. The method for controlling the inductive heating process according to claim 1, which further comprises recognizing an already warm said sleeve portion of the tool holder inserted into the induction coil of the induction coil unit, a preheating state of the sleeve portion being identified on a basis of an analyzed temporal profile or evaluated temporal profiles or an analyzed frequency profile or evaluated frequency profiles.

12. The method for controlling the inductive heating process according to claim 1, wherein:
the inductive heating process is an uninterrupted, inductive heating process; and
the decision is made, based on an analyzed profile or evaluated profiles, namely based on a profile behavior and/or a profile change and/or a profile change behavior.

13. The method for controlling the inductive heating process according to claim 4, wherein in the analysis of the frequency profile, the at least one extremum of a resonant frequency, a bandwidth or a variance is determined.

14. The method for controlling the inductive heating process according to claim 1, wherein in the analysis of the at least one temporal profile, root mean square current or voltage values at different times of the inductive heating process are compared using tangents or slope lines to the at least one temporal profile, and/or wherein, in an analysis of the frequency profile, the frequency profile to be analyzed is compared with a reference profile using an extremum and/or a band width or variance.

15. The method for controlling the inductive heating process according to claim 1, wherein the at least one temporal profile or the frequency profile to be analyzed is smoothed, averaged, filtered and/or normalized to a German or European reference mains voltage before an analysis and/or during the analysis.

16. The method for controlling the inductive heating process according to claim 1, which further comprises determining the at least one temporal profile or the frequency profile using a measurement of a root mean square current or a root mean square voltage.

17. The method for controlling the inductive heating process according to claim 1, wherein the input current and/or the input voltage is measured downstream of a rectifier, or upstream of the rectifier and/or at a connecting part.

18. An induction coil unit, comprising:
an induction coil for receiving a sleeve portion of a tool holder which is able to be inserted into said induction coil;
a circuit by way of which said induction coil is supplied with power; and
a controller by way of which said induction coil and said circuit are able to be controlled and which is configured for carrying out the method according to claim 1.

19. The induction coil unit according to claim 18, which further comprises using at least one measuring apparatus for measuring the at least one temporal profile or the frequency profile of the coil current and/or of the coil voltage and/or of the input current and/or of the input voltage.

20. The induction coil unit according to claim 19, wherein said at least one measuring apparatus is a current measuring apparatus or a voltage measuring apparatus and/or wherein said at least one measuring apparatus is installed in an input circuit and/or in an intermediate circuit and/or in a coil circuit of said circuit.
